(19) United States
(12) Patent Application Publication
(10) Pub. No.: US 2012/0124298 A1
(43) Pub. Date: May 17, 2012

(54) LOCAL SYNCHRONIZATION IN A MEMORY HIERARCHY

(75) Inventors: ANDREW KENNETH MARTIN, Austin, TX (US); Michael David Kistler, Austin, TX (US); Robert W. Wisniewski, Ossining, NY (US)

(73) Assignee: International Business Machines Corporation, Armonk, NY (US)

(21) Appl. No.: 12/948,058

(22) Filed: Nov. 17, 2010

(51) Int. Cl. G06F 12/00

(52) U.S. Cl. 711/141; 711/E12.026

(57) ABSTRACT

A method, system, and computer usable program product for local synchronization in a memory hierarchy in a multi-core data processing system are provided in the illustrative embodiments. A request to acquire a reservation for a reservation granule is received at a first core. The reservation is acquired in a first local cache associated with the first core in response to a cache line including the reservation granule being present and writable in the first local cache. A conditional store request to store at the reservation granule is received at the first core. A determination is made whether the reservation remains held at the first local cache. The store operation is performed at the first local cache responsive to reservation remaining held at the first local cache.

### BACKGROUND OF THE INVENTION

1. Field of the Invention

The present invention relates generally to an improved data processing system, and in particular, to a computer implemented method for improving memory operations in a multiprocessor or multi-core data processing environment. Still more particularly, the present invention relates to a computer-implemented method, system, and computer-usable program code for local synchronization in a memory hierarchy in a multiprocessor or multi-core data processing environment.

2. Description of the Related Art

Data processing systems include processors for performing computations. A processor can include multiple processing cores. A core is a processor or a unit of a processor circuitry that is capable of operating as a separate processing unit. Some data processing systems can include multiple processors. A data processing environment can include data processing systems including single processors, multi-core processors, and multiprocessor configurations. A data processing system including multiple cores is also called a node.

For the purposes of this disclosure, a data processing environment including multiple processors or processors with multiple cores is collectively referred to as a multiprocessor environment.

The cores in a node may reference, access, and manipulate a common region of memory. In a multiprocessor environment, cores in different nodes may also reference, access, and manipulate a common region of memory, such as by utilizing a coherence bus.

A coherence bus is an infrastructure component that coordinates memory transactions across multiple nodes that utilize a common memory. Coherence is the process of maintaining integrity of data in a given memory. A coherence protocol is an established method of ensuring coherence.

Synchronization, generally, is a process of ensuring that different cores manipulating the same reservation granule are not overstepping each other. A reservation granule is a memory address, and may be a cache line containing that address.

Reservation is a process of obtaining access to a reservation granule such that a node acquiring the reservation may read the reservation granule and may write data at the reservation granule if no other node has modified the data at the reservation granule between the time the first node acquires the reservation and the time the first node attempts to write at the reservation granule under a reservation.

Thus, synchronization is a process of ensuring that a node does not overwrite the result of another node's update, write, or store operation at a memory address, before that result is propagated to all nodes using that memory address. In other words, synchronization is the process of keeping multiple copies of data, such as data from a common area of a memory stored in caches of several cores, in coherence with one another to maintain data integrity.

### SUMMARY OF THE INVENTION

The illustrative embodiments provide a method, system, and computer usable program product for local synchronization in memory hierarchy.

An embodiment receives, at a first core, a request to acquire a reservation for a reservation granule. The embodiment acquires the reservation in a first local cache associated with the first core in response to a cache line including the reservation granule being present and writable in the first local cache. The embodiment receives, at the first core, a conditional store request to store at the reservation granule. The embodiment determines whether the reservation remains held at the first local cache. The embodiment performs a conditional store operation according to the conditional store request at the first local cache responsive to reservation remaining held at the first local cache.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a block diagram of a data processing system in which the illustrative embodiments may be implemented is depicted;

FIG. 2 depicts a block diagram of an example logical partitioned platform in which the illustrative embodiments may be implemented;

FIG. 3 depicts a block diagram of an example multi-core system and associated memory hierarchy with respect to which an illustrative embodiment may be implemented;

FIG. 4 depicts a block diagram of a state in the performance of local synchronization in a memory hierarchy in accordance with an illustrative embodiment;

FIG. 5 depicts a block diagram of another state in the performance of local synchronization in a memory hierarchy in accordance with an illustrative embodiment;

FIG. 6 depicts a block diagram of another state in the performance of local synchronization in a memory hierarchy in accordance with an illustrative embodiment;

FIG. 7 depicts a block diagram of another state in the performance of local synchronization in a memory hierarchy in accordance with an illustrative embodiment;

FIG. 8 depicts a block diagram of another state in the performance of local synchronization in a memory hierarchy in accordance with an illustrative embodiment;

FIG. 9 depicts a block diagram of another state in the performance of local synchronization in a memory hierarchy in accordance with an illustrative embodiment;

FIG. 10 depicts a flowchart of an example process of acquiring a reservation for synchronization in accordance with an illustrative embodiment; and

FIG. 11 depicts a flowchart of an example process of synchronization in a memory hierarchy in accordance with an illustrative embodiment.

### DETAILED DESCRIPTION OF THE PREFERRED EMBODIMENT

The number of cores that operate in parallel is increasing. The cores, whether across multiple processors on a multiprocessor machine or within a single chip, need an efficient way to perform synchronization. Some presently available solutions, such as atomic primitives, attempt to improve the synchronization efficiencies.

However, the invention recognizes that as the number of cores increases, to achieve desirable performance metrics, software must, as much as possible, perform local operations. Local operations are operations performed using the local cache of a core that is performing the operation. The local cache is also known as level 1 cache (L1). Remote or global operations are operations that the core has to perform in a memory area away from the local cache, such as a level 2 cache (L2) or level 3 cache (L3).

In a typical memory hierarchy in multi-core systems, a core has an associated L1 that is closest to the core. For operations, such as synchronization, several cores in the same node utilize L2, which is farther from a core relative to the core's L1. Cores across different nodes may similarly operate on shared data using L3, which is still farther from a core as compared to the core's L2. Far or near distances between different caches and a core are references to comparatively larger or fewer number of processor cycles needed to perform similar operations using the different caches.

The invention recognizes that when multiple cores participate in the execution of a software product, global operations prevent the software from utilizing the full capability of the data processing system. In some cases, the performance of the software executing on multiple cores may be no better than the performance of the same software executing on a single core.

The invention further recognizes that even if software is so designed as to keep many operations local, current hardware mechanisms perform synchronization at best at L2, which is a far distance from the core. For example, a store operation using synchronization at L2 may consume upwards of one hundred processor cycles whereas the same store operation may execute in less than ten cycles if synchronization were possible using L1.

The illustrative embodiments used to describe the invention generally address and solve the above-described problems and other problems related to synchronization in multi-core environments where memory is organized into a hierarchy. The illustrative embodiments of the invention provide a method, computer usable program product, and data processing system for local synchronization in a memory hierarchy in multi-core systems. An illustrative embodiment provides a mechanism to allow operations with respect to an address, such as successive atomic operations of synchronization, to be handled locally at the core that is performing the operations. For example, an embodiment may allow a core to perform synchronization using the core's L1, and fall back the synchronization to L2 or beyond only as needed, such as when multiple cores begin performing operations on the same address.

The illustrative embodiments are described with respect to data, data structures, and identifiers only as examples. Such descriptions are not intended to be limiting on the invention. For example, an illustrative embodiment described with respect to one type of instruction may be implemented using a different instruction in a different configuration, in a similar manner within the scope of the invention. Generally, the invention is not limited to any particular message or command set that may be usable in a multiprocessor environment.

Furthermore, the illustrative embodiments may be implemented with respect to any type of data processing system. For example, an illustrative embodiment described with respect to a processor may be implemented in a multi-core processor or a multiprocessor system within the scope of the invention. As another example, an embodiment of the invention may be implemented with respect to any type of client system, server system, platform, or a combination thereof.

The illustrative embodiments are further described with respect to certain parameters, attributes, and configurations only as examples. Such descriptions are not intended to be limiting on the invention.

An implementation of an embodiment may take the form of data objects, code objects, encapsulated instructions, application fragments, distributed application or a portion thereof, drivers, routines, services, systems—including basic I/O system (BIOS), and other types of software implementations available in a data processing environment. For example, Java® Virtual Machine (JVM®), Java® object, an Enterprise Java Bean (EJB®), a servlet, or an applet may be manifestations of an application with respect to which, within which, or using which, the invention may be implemented. (Java, JVM, EJB, and other Java related terminologies are registered trademarks of Sun Microsystems, Inc. or Oracle Corporation in the United States and other countries.)

An illustrative embodiment may be implemented in hardware, software, or a combination of hardware and software. The examples in this disclosure are used only for the clarity of the description and are not limiting on the illustrative embodiments. Additional or different information, data, operations, actions, tasks, activities, and manipulations will be conceivable from this disclosure for similar purpose and the same are contemplated within the scope of the illustrative embodiments.

The illustrative embodiments are described using specific code, data structures, files, file systems, logs, designs, architectures, layouts, schematics, and tools only as examples and are not limiting on the illustrative embodiments. Furthermore, the illustrative embodiments are described in some instances using particular data processing environments only as an example for the clarity of the description. The illustrative embodiments may be used in conjunction with other comparable or similarly purposed structures, systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

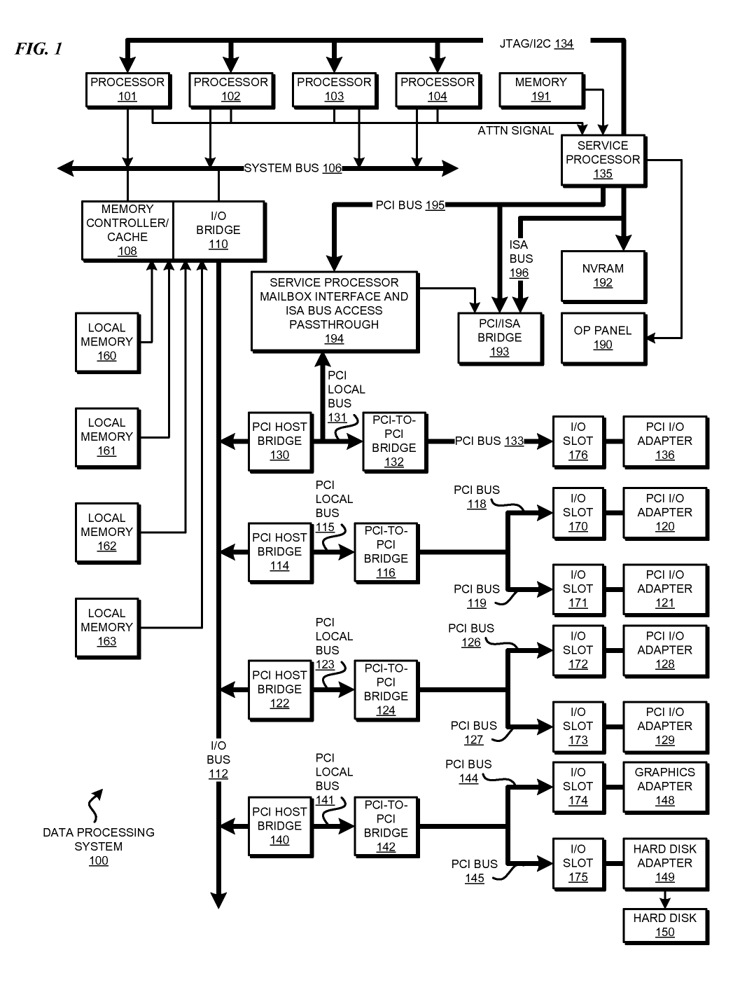

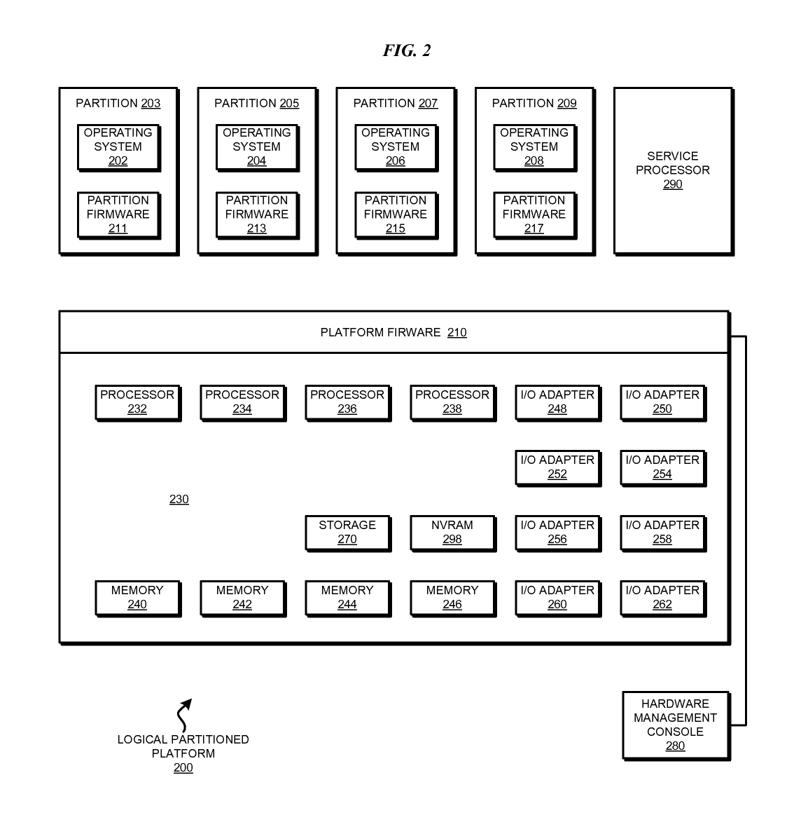

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

With reference to FIG. 1, this figure depicts a block diagram of a data processing system in which the illustrative embodiments may be implemented is depicted. Data processing system 100 may be a symmetric multiprocessor (SMP) system including a plurality of processors 101, 102, 103, and 104, which connect to system bus 106. For example, data processing system 100 may be an IBM Power System® implemented as a server within a network. (Power Systems is a product and a trademark of International Business Machines Corporation in the United States and other countries). Alternatively, a single processor system may be employed and processors 101, 102, 103, and 104 may be cores in the single processor chip. Alternatively, data processing system 100 may include processors 101, 102, 103, 104 in any combination of processors and cores.

Also connected to system bus 106 is memory controller/cache 108, which provides an interface to a plurality of local memories 160-163. I/O bus bridge 110 connects to system bus 106 and provides an interface to I/O bus 112. Memory controller/cache 108 and I/O bus bridge 110 may be integrated as depicted.

Data processing system 100 is a logical partitioned data processing system. Thus, data processing system 100 may have multiple heterogeneous operating systems (or multiple instances of a single operating system) running simultaneously. Each of these multiple operating systems may have any number of software programs executing within it. Data processing system 100 is logically partitioned such that different PCI I/O adapters 120-121, 128-129, and 136, graphics adapter 148, and hard disk adapter 149 may be assigned to different logical partitions. In this case, graphics adapter 148 connects for a display device (not shown), while hard disk adapter 149 connects to and controls hard disk 150.

Thus, for example, suppose data processing system 100 is divided into three logical partitions, P1, P2, and P3. Each of PCI I/O adapters 120-121, 128-129, 136, graphics adapter 148, hard disk adapter 149, each of host processors 101-104, and memory from local memories 160-163 is assigned to each of the three partitions. In these examples, memories 160-163 may take the form of dual in-line memory modules (DIMMs). DIMMs are not normally assigned on a per DIMM basis to partitions. Instead, a partition will get a portion of the overall memory seen by the platform. For example, processor 101, some portion of memory from local memories 160-163, and I/O adapters 120, 128, and 129 may be assigned to logical partition P1; processors 102-103, some portion of memory from local memories 160-163, and PCI I/O adapters 121 and 136 may be assigned to partition P2; and processor 104, some portion of memory from local memories 160-163, graphics adapter 148 and hard disk adapter 149 may be assigned to logical partition P3.

Each operating system executing within data processing system 100 is assigned to a different logical partition. Thus, each operating system executing within data processing system 100 may access only those I/O units that are within its logical partition. Thus, for example, one instance of the Advanced Interactive Executive (AIX®) operating system may be executing within partition P1, a second instance (image) of the AIX operating system may be executing within partition P2, and a Linux® or IBM-i® operating system may be operating within logical partition P3. (AIX and IBM-i are trademarks of International business Machines Corporation in the United States and other countries. Linux is a trademark of Linus Torvalds in the United States and other countries).

Peripheral component interconnect (PCI) host bridge 114 connected to I/O bus 112 provides an interface to PCI local bus 115. A number of PCI input/output adapters 120-121 connect to PCI local bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI local bus 123. PCI local bus 123 connects to a plurality of PCI I/O adapters 128-129. PCI I/O adapters 128-129 connect to PCI local bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. Consequently, data processing system 100 allows connections to multiple network computers.

A memory mapped graphics adapter 148 is inserted into I/O slot 174 and connects to I/O bus 112 through PCI bus 144, PCI-to-PCI bridge 142, PCI local bus 141, and PCI host bridge 140. Hard disk adapter 149 may be placed into I/O slot 175, which connects to PCI bus 145. In turn, this bus connects to PCI-to-PCI bridge 142, which connects to PCI host bridge 140 by PCI local bus 141.

A PCI host bridge 130 provides an interface for a PCI local bus 131 to connect to I/O bus 112. PCI I/O adapter 136 connects to I/O slot 176, which connects to PCI-to-PCI bridge 132 by PCI bus 133. PCI-to-PCI bridge 132 connects to PCI local bus 131. This PCI bus also connects PCI host bridge 130 to the service processor mailbox interface and ISA bus access pass-through logic 194 and PCI-to-PCI bridge 132.

Service processor mailbox interface and ISA bus access pass-through logic 194 forwards PCI accesses destined to the PCI/ISA bridge 193. NVRAM storage 192 connects to the ISA bus 196. Service processor 135 connects to service processor mailbox interface and ISA bus access pass-through logic 194 through its local PCI bus 195. Service processor 135 also connects to processors 101-104 via a plurality of JTAG/I2C busses 134. JTAG/I2C busses 134 are a combination of JTAG/scan busses (see IEEE 1149.1) and Phillips I2C busses.

However, alternatively, JTAG/I2C busses 134 may be replaced by only Phillips I2C busses or only JTAG/scan busses. All SP-ATTN signals of the host processors 101, 102, 103, and 104 connect together to an interrupt input signal of service processor 135. Service processor 135 has its own local memory 191 and has access to the hardware OP-panel 190.

When data processing system 100 is initially powered up, service processor 135 uses the JTAG/I2C busses 134 to interrogate the system (host) processors 101-104, memory controller/cache 108, and I/O bridge 110. At the completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101-104, memory controller/cache 108, and I/O bridge 110. Any error information for failures detected during the BISTs, BATs, and memory tests are gathered and reported by service processor 135.

If a meaningful/valid configuration of system resources is still possible after taking out the elements found to be faulty during the BISTs, BATs, and memory tests, then data processing system 100 is allowed to proceed to load executable code into local (host) memories 160-163. Service processor 135 then releases host processors 101-104 for execution of the code loaded into local memory 160-163. While host processors 101-104 are executing code from respective operating systems within data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101-104, local memories 160-163, and I/O bridge 110.

Service processor 135 saves and reports error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for deconfiguration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using IBM Power Systems available from International Business Machines Corporation. Such a system may support logical partitioning using an AIX operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the illustrative embodiments.

With reference to FIG. 2, this figure depicts a block diagram of an example logical partitioned platform in which the illustrative embodiments may be implemented. The hardware in logical partitioned platform 200 may be implemented as, for example, data processing system 100 in FIG. 1.

Logical partitioned platform 200 includes partitioned hardware 230, operating systems 202, 204, 206, 208, and platform firmware 210. A platform firmware, such as platform firmware 210, is also known as partition management firmware. Operating systems 202, 204, 206, and 208 may be multiple copies of a single operating system or multiple heterogeneous operating systems simultaneously run on logical partitioned platform 200. These operating systems may be implemented using IBM-i, which are designed to interface with a partition management firmware, such as Hypervisor. IBM-i is used only as an example in these illustrative embodiments. Of course, other types of operating systems, such as AIX and Linux, may be used depending on the particular implementation. Operating systems 202, 204, 206, and 208 are located in partitions 203, 205, 207, and 209.

Hypervisor software is an example of software that may be used to implement partition management firmware 210 and is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Additionally, these partitions also include partition firmware 211, 213, 215, and 217. Partition firmware 211, 213, 215, and 217 may be implemented using initial boot strap code, IEEE-1275 Standard Open Firmware, and runtime abstraction software (RTAS), which is available from International Business Machines Corporation. When partitions 203, 205, 207, and 209 are instantiated, a copy of boot strap code is loaded onto partitions 203, 205, 207, and 209 by platform firmware 210. Thereafter, control is transferred to the boot strap code with the boot strap code then loading the open firmware and RTAS. The processors associated or assigned to the partitions are then dispatched to the partition's memory to execute the partition firmware.

Partitioned hardware 230 includes a plurality of processors 232-238, a plurality of system memory units 240-246, a plurality of input/output (I/O) adapters 248-262, and a storage unit 270. Each of the processors 232-238, memory units 240-246, NVRAM storage 298, and I/O adapters 248-262 may be assigned to one of multiple partitions within logical partitioned platform 200, each of which corresponds to one of operating systems 202, 204, 206, and 208.

Partition management firmware 210 performs a number of functions and services for partitions 203, 205, 207, and 209 to create and enforce the partitioning of logical partitioned platform 200. Partition management firmware 210 is a firmware implemented virtual machine identical to the underlying hardware. Thus, partition management firmware 210 allows the simultaneous execution of independent OS images 202, 204, 206, and 208 by virtualizing all the hardware resources of logical partitioned platform 200.

Service processor 290 may be used to provide various services, such as processing of platform errors in the partitions. These services also may act as a service agent to report errors back to a vendor, such as International Business Machines Corporation. Operations of the different partitions may be controlled through a hardware management console, such as hardware management console 280. Hardware management console 280 is a separate data processing system from which a system administrator may perform various functions including reallocation of resources to different partitions.

The hardware in FIGS. 1-2 may vary depending on the implementation. Other internal hardware or peripheral devices, such as flash memory, equivalent non-volatile memory, or optical disk drives and the like, may be used in addition to or in place of certain hardware depicted in FIGS. 1-2. An implementation of the illustrative embodiments may also use alternative architecture for managing partitions without departing from the scope of the invention.

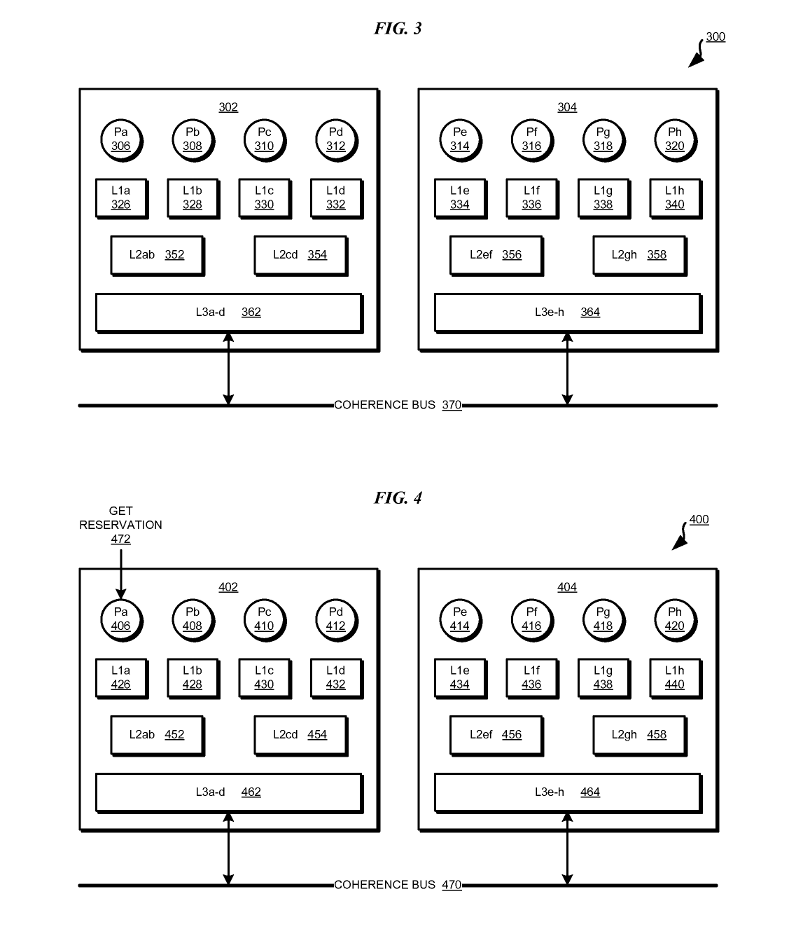

With reference to FIG. 3, this figure depicts a block diagram of an example multi-core system and associated memory hierarchy with respect to which an illustrative embodiment may be implemented. Configuration 300 is an example multi-node multi-core data processing system. Nodes 302 and node 304 may each be, for example, similar to data processing system 100 in FIG. 1. Node 302 may include cores “Pa” 306, “Pb” 308, “Pc” 310, and “Pd” 312. Node 304 may include cores “Pe” 314, “Pf” 316, “Pg” 318, and “Ph” 320. Any of cores 306-320 may be a processor, such as processor 102 in FIG. 1 or a core therein.

“L1a” 326 is a L1 cache associated with Pa 306. “L1b” 328 is a L1 cache associated with Pb 308. “L1c” 330 is a L1 cache associated with Pc 310. “L1d” 332 is a L1 cache associated with Pd 312. “L1e” 334 is a L1 associated cache with Pe 314. “L1f” 336 is a L1 cache associated with Pf 316. “L1g” 338 is a L1 cache associated with Pg 318. “L1h” 340 is a L1 cache associated with Ph 320.

“L2ab” 352 is a L2 cache associated with Pa 306 and Pb 308. “L2cd” 354 is a L2 cache associated with Pc 310 and Pd 312. “L2ef” 356 is a L2 cache associated with Pe 314 and Pf 316. “L2gh” 358 is a L2 cache associated with Pg 318 and Ph 320.

“L3a-d” 362 is a L3 cache associated with all cores of node 302, to wit, Pa 306, Pb 308, Pc 310, and Pd 312. “L3e-h” 364 is a L3 cache associated with all cores of node 304, to wit, Pe 314, Pf 316, Pg 318, and Ph 320. Coherence bus 370 maintains coherence across L3a-d 362 and L3e-h 364.

Typically, L2 cache and L3 cache are both attached to a coherence bus. Presently, highest coherence level within a node is maintained at L2 cache. For example, for synchronization coherence in node 302, reservations may have to be held at L2ab 352, L2cd 354, or L3a-d 362 depending on which of cores Pa 306, Pb 308, Pc 310, and Pd 312 were simultaneously holding reservations or conducting operations on a common reservation granule. As another example, for synchronization coherence across nodes 302 and 304, reservations may have to be held at L3a-d 362 and L3e-h 364 if Pa 306 and Pe 314 were simultaneously holding reservations or conducting operations on a common reservation granule.

The invention recognizes that with presently available methods of synchronization, without the benefit of an embodiment of the invention, even when only Pa 306 were holding a reservation, the reservation has to be held at a L2 cache, to wit, at L2ab 352. Holding the reservation at L2ab 352 makes checking the reservation for a store operation from Pa 306 over a hundred processor cycles long in some cases.

FIGS. 4-9 describe an example synchronization operation using an illustrative embodiment. The example synchronization operation acquires a reservation on a reservation granule, such as for reading a memory address. According to an embodiment, the reservation is held at the closest possible level in an associated memory hierarchy, such as at L1. The reservation is migrated progressively farther away in that hierarchy, such as to L2 or L3, depending upon the actions of other cores.

The synchronization operation attempts to use the reservation for performing a store operation on the reservation granule. The reservation may be found at L1, L2, or L3, or may be lost altogether depending upon the actions of other cores with respect to that reservation granule. Thus, advantageously, according to an illustrative embodiment, at least in some instances, and for some synchronization operations, the reservation can be maintained at L1 and selectively migrated to more distant memory in the memory hierarchy.

With respect to FIG. 4, this figure depicts a block diagram of a state in the performance of local synchronization in a memory hierarchy in accordance with an illustrative embodiment. Artifacts 402-470 in configuration 400 are analogous to the corresponding artifacts 302-370 described in configuration 300 in FIG. 3.

The state depicted in this figure is achieved when core Pa 406 receives instruction 472 to acquire a reservation on a specified reservation granule.

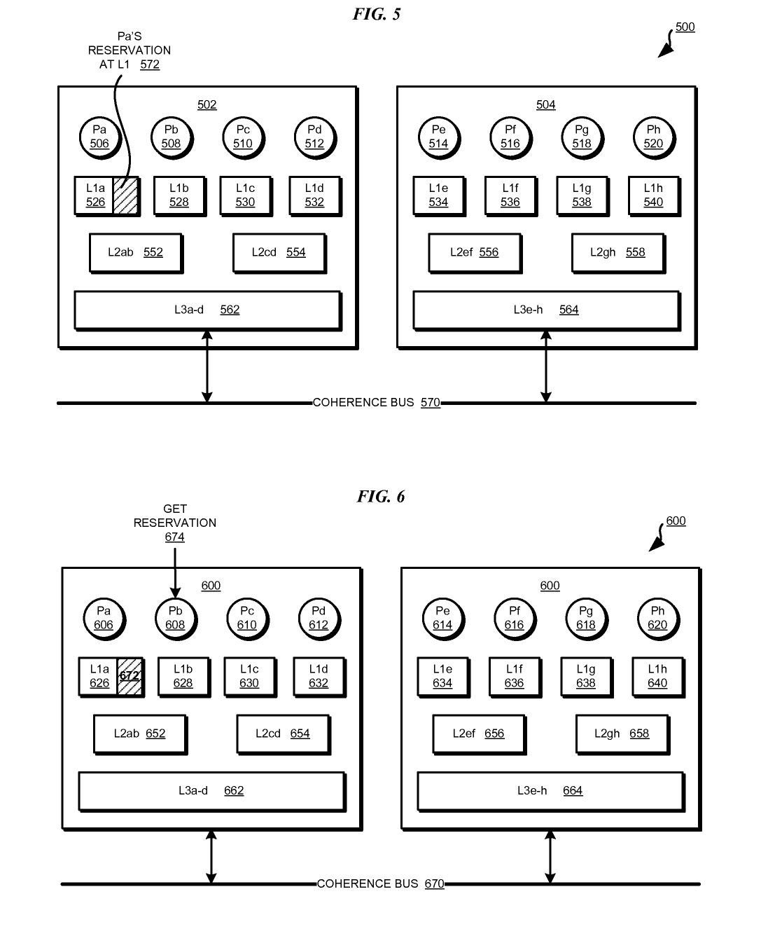

With respect to FIG. 5, this figure depicts a block diagram of another state in the performance of local synchronization in a memory hierarchy in accordance with an illustrative embodiment. Artifacts 502-570 in configuration 500 are analogous to the corresponding artifacts 402-470 described in configuration 400 in FIG. 4.

Core Pa 506 determines whether the requested address is already reserved by cores other than core 506 elsewhere in the system. The state depicted in this figure is achieved when the requested address is not reserved by cores other than core 506. According to the embodiment, core Pa 506's reservation 572 corresponding to the reservation requested in request 472 in FIG. 4 is held at L1 cache L1a 526

With respect to FIG. 6, this figure depicts a block diagram of another state in the performance of local synchronization in a memory hierarchy in accordance with an illustrative embodiment. Artifacts 602-672 in configuration 600 are analogous to the corresponding artifacts 502-572 described in configuration 500 in FIG. 5.

The state depicted in this figure is achieved when core Pb 608 receives instruction 674 to acquire a reservation on the same reservation granule for which reservation 572 in FIG. 5 is being held for Pa 606.

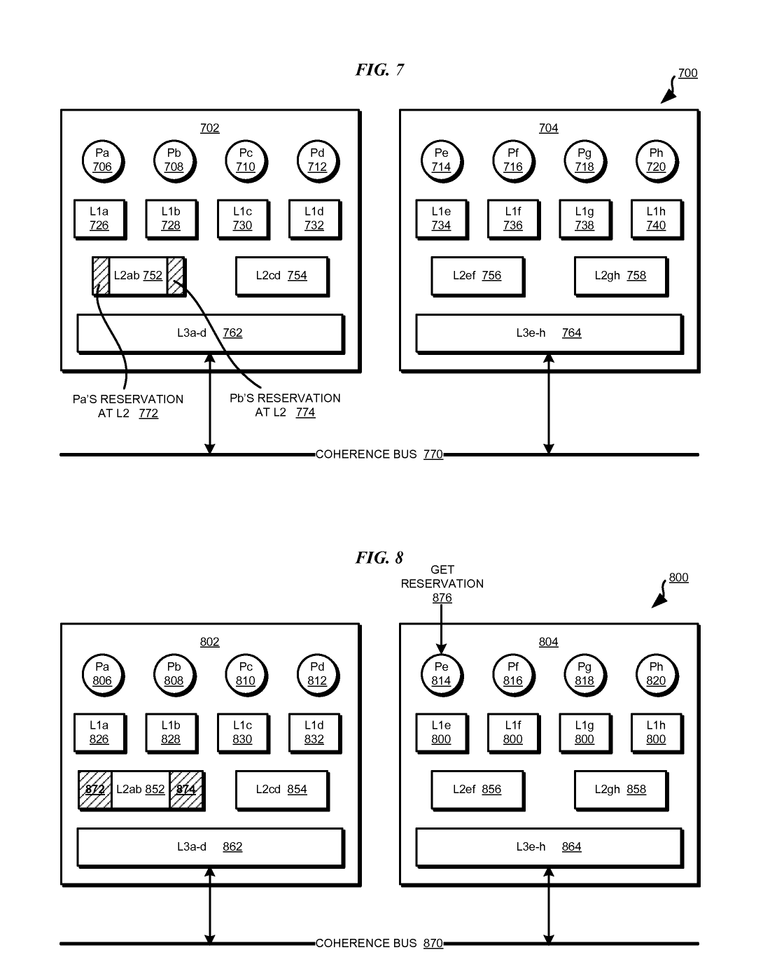

With respect to FIG. 7, this figure depicts a block diagram of another state in the performance of local synchronization in a memory hierarchy in accordance with an illustrative embodiment. Artifacts 702-770 in configuration 700 are analogous to the corresponding artifacts 602-670 described in configuration 600 in FIG. 6.

Core Pb 708 determines whether the requested address is already reserved by cores other than core 708 elsewhere in the system. According to the example operation being depicted in FIGS. 4-9, the requested address may be available in L1b 728, but may not be writable because Pa 706 has already acquired a reservation on that address as described in FIG. 5. Accordingly, core Pa 706's reservation 772 is migrated from L1a 726 to that L2 cache where coherence can be maintained between the data used by Pa 706 and Pb 708, to wit, L2ab 752. Core Pb 708 acquires reservation 774 at L2ab 752 accordingly.

Alternatively, the requested address may not be available at all in L1b 726. Consequently, requesting the reservation at L2ab 752 may be appropriate for that alternative reason as well.

With respect to FIG. 8, this figure depicts a block diagram of another state in the performance of local synchronization in a memory hierarchy in accordance with an illustrative embodiment. Artifacts 802-874 in configuration 800 are analogous to the corresponding artifacts 702-774 described in configuration 700 in FIG. 7.

The state depicted in this figure is achieved when core Pe 814 receives instruction 876 to acquire a reservation on the same reservation granule for which reservations 872 and 874 are being held for Pa 806 and Pb 808 respectively.

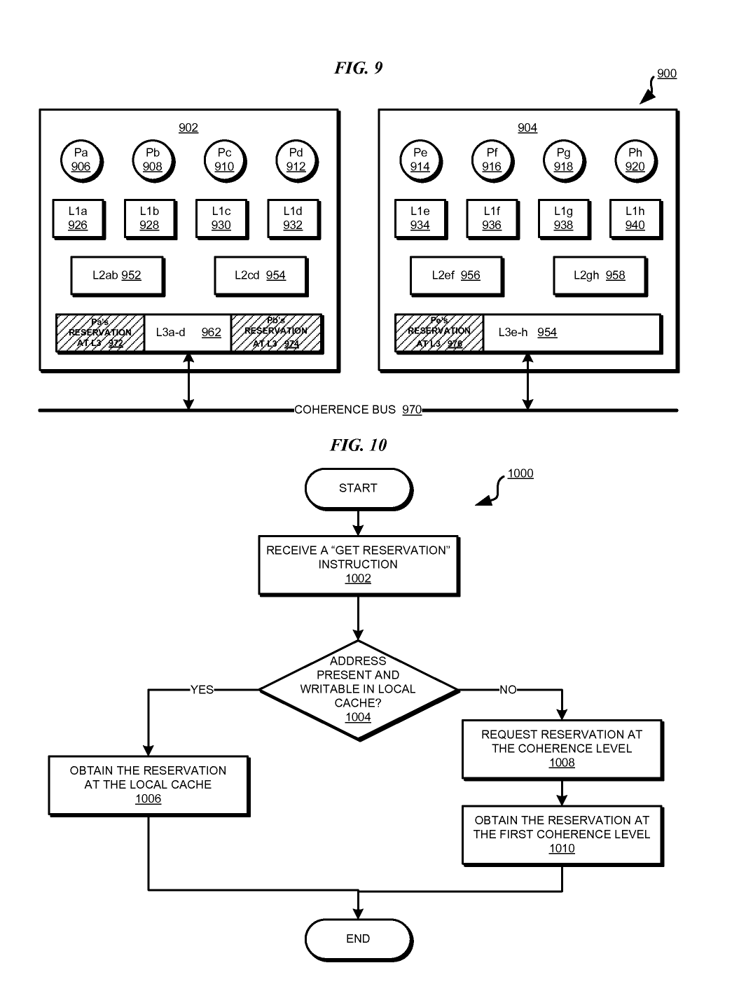

With respect to FIG. 9, this figure depicts a block diagram of another state in the performance of local synchronization in a memory hierarchy in accordance with an illustrative embodiment. Artifacts 902-970 in configuration 900 are analogous to the corresponding artifacts 802-870 described in configuration 800 in FIG. 8.

Core Pe 914 determines whether the requested address is already reserved by cores other than core 914 elsewhere in the system. According to the example operation being depicted in FIGS. 4-9, the requested address may be available in L1e 934, but may not be writable because Pa 906 has already acquired a reservation on that address as described in FIG. 5 and Pb 908 has also acquired a reservation on that address as described in FIG. 7. Core Pe 914 may not be able to acquire a reservation at L2ef 956 either for the same reason.

The highest point of coherence between Pa 906, Pb 908, and Pe 914 is at L3 cache L3e-h 964, which is coherent with L3 cache L3a-d 962 in node 902 over coherence bus 970. Accordingly, core Pa 906's reservation 972 and core Pb 908's reservation 974 are migrated from L2ab 952 to L3 cache L3a-d 962 where coherence can be maintained between the data used by Pa 906, Pb 908, and Pe 914. Core Pe 914 acquires reservation 976 at L3e-h 964 accordingly.

Alternatively, the requested address may not be available at all in L1e 934 or L2ef 956. Consequently, requesting the reservation at L3e-h 964 may be appropriate for that alternative reason as well.

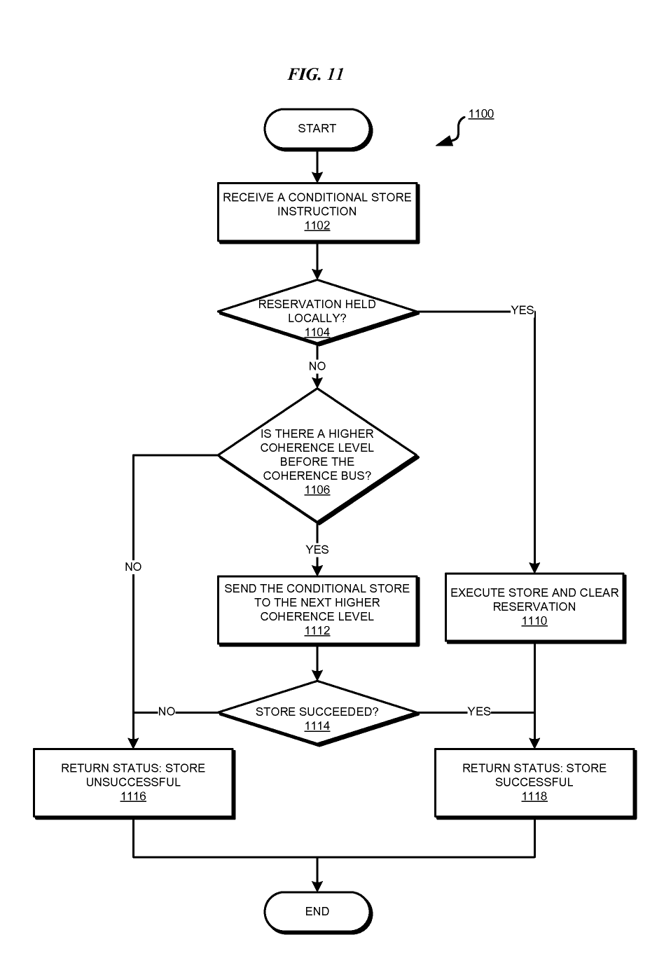

With reference to FIG. 10, this figure depicts a flowchart of an example process of acquiring a reservation for synchronization in accordance with an illustrative embodiment. Process 1000 may be implemented in a hardware or software suitable for handling the reservation requests from cores to a memory hierarchy, such as depicted in FIGS. 3-9.

Process 1000 begins by receiving a request to acquire a reservation on a reservation granule (step 1002). Process 1000 determines whether the requested address or granule is available and writable in the local cache, such as an associated L1 cache (step 1004).

If the requested address or granule is available and writable in the local cache (“Yes’ path of step 1004), process 1000 obtains the reservation at the local cache level (step 1006). If the requested address or granule is not available or available but not writable in the local cache (“No” path of step 1004), process 1000 requests the reservation at the next coherence level (step 1008). Process 1000 obtains the reservation at the first coherence level, or the coherence level closest to the core that is requesting the reservation, (step 1010). The first coherence level may be the local cache if no other cores hold a reservation on this coherence granule.

With reference to FIG. 11, this figure depicts a flowchart of an example process of synchronization in a memory hierarchy in accordance with an illustrative embodiment. Process 1100 may be implemented where process 1000 in FIG. 10 may be implemented.

Process 1100 begins by receiving a conditional store instruction, such as a conditional write in a synchronization operation (step 1102). Process 1100 determines whether a reservation, such as a previously acquired reservation is being held locally (step 1104). For example, since acquiring the reservation on a reservation granule, another core may have performed a write or store operation on that reservation granule or an address therein, causing all previously held reservations on that reservation granule to become invalid.

If the reservation is being held locally (“Yes” path of step 1104), process 1100 performs the store operation in the local cache (which may be a pass through cache) and clears the reservation (step 1110). If the reservation is not held locally (“No” path of step 1104), process 1100 determines whether a higher coherence level exists before the coherence bus (step 1106).

If no higher coherence level exists before the coherence bus (“No” path of step 1106), process 1100 proceeds to step 1116. If a higher coherence level exists (“Yes” path of step 1106), process 1100 sends the conditional store of step 1102 to the next higher coherence level (step 1112). The request may pass to the coherence level closest to the requesting core or to a more distant coherence level depending on the activities of other cores since the reservation was first acquired.

Process 1100 determines whether the store succeeded at that coherence level (step 1114). The store may succeed at some coherence level, or may be declined. If the store fails at a given coherence level (“No” path of step 1114), process 1100 may return a status to the requesting core informing the core that the store was unsuccessful (step 1116). Process 1100 may end thereafter.

Note that the execution of steps 1112 and 1114 may be iterative (not shown), in searching a given memory hierarchy for coherence levels and reservations therein. In other words, for performing step 1112 and step 1114 at one coherence level, process 1100 may search through the memory hierarchy to identify the coherence levels. Upon finding a coherence level, process 1100 may make the conditional store request of step 1112 for the identified coherence level. Process 1110 may then evaluate whether the conditional store was successful or unsuccessful in step 1114. If the conditional store is not successful at that coherence level, process 1100 returns a status to the requesting core informing the core that the store was unsuccessful according to step 1116.

If the conditional store is successful at some coherence level (“Yes” path of step 1114), process 1100 returns a status indication that the conditional store was successful (step 1118). Process 1100 ends thereafter.

The components in the block diagrams and the steps in the flowcharts described above are described only as examples. The components and the steps have been selected for the clarity of the description and are not limiting on the illustrative embodiments of the invention. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the invention.

Thus, a computer implemented method, apparatus, and computer program product are provided in the illustrative embodiments for local synchronization in memory hierarchy in multi-core systems. The acquiring of a reservation is linked to some form of reading the shared state of the system, which may mean reading the contents of shared memory. The store-conditional is linked to writing that same state. If the reservation is (still) held at the time the store conditional is executed, the store succeeds and shared memory is updated. If the reservation is not held, or no longer held, the store fails, and shared memory is not updated.

According to the invention, for a reduced cost store-conditional operation and other operations requiring checking whether a reservation is held, a process essentially has to decide at what level in a given memory hierarchy a reservation is to be held; the process has to migrate reservations for maintaining coherency of the shared memory system; the process has to cancel reservations when the state of the shared memory changes; and the process has to determine whether store-conditionals succeed or fail. An advantage of the invention is the ability to be able to perform the decide, cancel, and determine steps locally when possible.

An embodiment of the invention holds reservations as locally as possible, and migrates them as needed so that reservations for any given reservation granule are held at the innermost level that encloses all the cores that hold reservations on a given reservation granule within a given coherently attached cluster, or at the point of coherent attachment if the reservations spans multiple clusters. According to an embodiment, the decision to create and hold a reservation locally can be made by inspecting the local L1 cache. If a reservation granule is writable in the local L1 cache, then no other core can be holding a reservation on that line, so the reservation can be established locally. If the reservation granule is not writeable in the local L1 cache, then the request to establish a reservation must be passed up the hierarchy. The reservation may still ultimately be held locally, if no other cores turn out to have a reservation on the granule, but the reservation decision cannot be made locally. If other cores hold a reservation, reservation will have to be held higher in the hierarchy.

According to an embodiment, the decision to allow a conditional store to proceed can also be made locally if the reservation is held locally—in which case the store can proceed, or the reservation is not held locally but the cache line is writable in the local cache—in which case the conditional store fails. A reservation cannot exist elsewhere in the system if the line is locally writable. Note that even if the store proceeds, the cache line may or may not exist in the local cache and may or may not be writable. Certain coherence actions may still have to be taken to obtain a writable copy. Reservations are migrated as additional cores create reservations on the same granule. Reservations are cancelled when a store takes place, as is known to those of ordinary skill in the art. Any cache that is managing a reservation(s) treats the corresponding cache lines as if they were held in a shared state—the lines need not actually be held in the cache. When a core writes to such a line, the core requests the line in exclusive (writable) state. Known coherence actions notify the cache holding the reservation that the line must be scratched, causing the reservation on that line to be canceled.

Using an embodiment of the invention, reservations for operations, such as for synchronization, can be managed at the local cache of a core. The reservations can be managed at any level of the memory hierarchy and migrated from one level to another depending on the activities of cores with respect to a given reservation granule.

If the reservation request's address is present in the local cache and is writable in the local cache, the reservation can be held in the local cache and write operations can be performed in the local cache. If the write access is lost due to an operation by another core, the reservation may be lost and may have to be reacquired. If the write access is lost due to a read or load operation at the reservation granule by another core, the reservation is migrated to a coherence level suitable for maintaining data coherence between the two cores.

If a requested reservation granule or address is present in the local cache but is not writable, the request can be made for a writable-for-reservation at the suitable coherence level. If the write permission is granted, the reservation can be established locally. If write permission is not granted, the reservation can be held at the first, or closest, suitable coherence level, or at the final coherence point, such as a coherence level managed by the coherence bus, if no other suitable coherence level exists.

The invention can take the form of an embodiment containing both hardware and software elements. In a preferred embodiment, the invention is implemented in software or program code, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for local synchronization in a memory hierarchy in a multi-core data processing system, the computer implemented method comprising:
receiving, at a first core, a request to acquire a reservation for a reservation granule;
acquiring the reservation in a first local cache associated with the first core responsive to a cache line including the reservation granule being present and writable in the first local cache;
receiving, at the first core, a conditional store request to store at the reservation granule;
determining whether the reservation remains held at the first local cache; and
performing a conditional store operation according to the conditional store request at the first local cache responsive to reservation remaining held at the first local cache.

2. The computer implemented method of claim 1, further comprising:
determining whether the reservation is no longer held at the first local cache;
requesting the conditional store at a first coherence level in the plurality of coherence levels responsive to the determining being negative, the conditional store being passed to a second coherence level in the plurality of coherence levels when the first coherence fails to perform the conditional store; and
repeating the requesting the conditional store at coherence levels progressively farther from the first core until the conditional store one of (i) succeeds at some coherence level, and (ii) fails at all coherence levels.

3. The computer implemented method of claim 1, further comprising:
determining that a second core acquired a second reservation on the reservation granule; and
migrating the reservation to a coherence level where data coherence is maintained for the reservation granule between the first and the second cores.

4. The computer implemented method of claim 3, wherein the reservation is migrated to a closest coherence level to the first core from a plurality of coherence levels where data coherence can be maintained for the reservation granule.

5. The computer implemented method of claim 3, further comprising:
determining that the reservation is no longer held at the first local cache;
querying a plurality of cache levels to identify a cache level holding the reservation;
identifying the coherence level as holding the reservation;
requesting the conditional store at the coherence level; and
returning an indication of success of the conditional store at the coherence level.

6. The computer implemented method of claim 3, further comprising:
determining whether the cache line is writable in the first local cache;
failing the conditional store responsive to the cache line being writable and the reservation not being held in the first local cache; and
requesting the conditional store at the coherence level responsive to the cache line not being writable and the reservation not being held in the first local cache.

7. The computer implemented method of claim 1, wherein the first local cache is a level one cache of the first core, and wherein the reservation granule is an address in a memory in the memory hierarchy, further comprising:
determining that the cache line is writable in the first local cache but the reservation is no longer held at the first local cache; and
failing the conditional store operation in the first local cache.

8. A computer usable program product comprising a computer usable storage medium including computer usable code for local synchronization in a memory hierarchy in a multi-core data processing system, the computer usable program product comprising:
computer usable code for receiving, at a first core, a request to acquire a reservation for a reservation granule;
computer usable code for acquiring the reservation in a first local cache associated with the first core responsive to a cache line including the reservation granule being present and writable in the first local cache;
computer usable code for receiving, at the first core, a conditional store request to store at the reservation granule;
computer usable code for determining whether the reservation remains held at the first local cache; and
computer usable code for performing a conditional store operation according to the conditional store request at the first local cache responsive to reservation remaining held at the first local cache.

9. The computer usable program product of claim 8, further comprising:
computer usable code for determining whether the reservation is no longer held at the first local cache;
computer usable code for requesting the conditional store at a first coherence level in the plurality of coherence levels responsive to the determining being negative, the conditional store being passed to a second coherence level in the plurality of coherence levels when the first coherence fails to perform the conditional store; and
computer usable code for repeating the requesting the conditional store at coherence levels progressively farther from the first core until the conditional store one of (i) succeeds at some coherence level, and (ii) fails at all coherence levels.

10. The computer usable program product of claim 8, further comprising:
computer usable code for determining that a second core acquired a second reservation on the reservation granule; and
computer usable code for migrating the reservation to a coherence level where data coherence is maintained for the reservation granule between the first and the second cores.

11. The computer usable program product of claim 10, wherein the reservation is migrated to a closest coherence level to the first core from a plurality of coherence levels where data coherence can be maintained for the reservation granule.

12. The computer usable program product of claim 10, further comprising:
computer usable code for determining that the reservation is no longer held at the first local cache;
computer usable code for querying a plurality of cache levels to identify a cache level holding the reservation;
computer usable code for identifying the coherence level as holding the reservation;
computer usable code for requesting the conditional store at the coherence level; and
computer usable code for returning an indication of success of the conditional store at the coherence level.

13. The computer usable program product of claim 10, further comprising:
computer usable code for determining whether the cache line is writable in the first local cache;
computer usable code for failing the conditional store responsive to the cache line being writable and the reservation not being held in the first local cache; and
computer usable code for requesting the conditional store at the coherence level responsive to the cache line not being writable and the reservation not being held in the first local cache.

14. The computer usable program product of claim 8, wherein the first local cache is a level one cache of the first core, and wherein the reservation granule is an address in a memory in the memory hierarchy, further comprising:
computer usable code for determining that the cache line is writable in the first local cache but the reservation is no longer held at the first local cache; and
computer usable code for failing the conditional store operation in the first local cache.

15. The computer usable program product of claim 8, wherein the computer usable code is stored in a computer readable storage medium in a data processing system, and wherein the computer usable code is transferred over a network from a remote data processing system.

16. The computer usable program product of claim 8, wherein the computer usable code is stored in a computer readable storage medium in a server data processing system, and wherein the computer usable code is downloaded over a network to a remote data processing system for use in a computer readable storage medium associated with the remote data processing system.

17. A data processing system for local synchronization in a memory hierarchy in a multi-core system, the data processing system comprising:
a storage device including a storage medium, wherein the storage device stores computer usable program code; and
a processor, wherein the processor executes the computer usable program code, and wherein the computer usable program code comprises:
computer usable code for receiving, at a first core, a request to acquire a reservation for a reservation granule;
computer usable code for acquiring the reservation in a first local cache associated with the first core responsive to a cache line including the reservation granule being present and writable in the first local cache;
computer usable code for receiving, at the first core, a conditional store request to store at the reservation granule;
computer usable code for determining whether the reservation remains held at the first local cache; and
computer usable code for performing a conditional store operation according to the conditional store request at the first local cache responsive to reservation remaining held at the first local cache.

18. The data processing system of claim 17, further comprising:
computer usable code for determining whether the reservation is no longer held at the first local cache;
computer usable code for requesting the conditional store at a first coherence level in the plurality of coherence levels responsive to the determining being negative, the conditional store being passed to a second coherence level in the plurality of coherence levels when the first coherence fails to perform the conditional store; and
computer usable code for repeating the requesting the conditional store at coherence levels progressively farther from the first core until the conditional store one of (i) succeeds at some coherence level, and (ii) fails at all coherence levels.

19. The data processing system of claim 17, further comprising:
computer usable code for determining that a second core acquired a second reservation on the reservation granule; and
computer usable code for migrating the reservation to a coherence level where data coherence is maintained for the reservation granule between the first and the second cores.

20. The data processing system of claim 19, further comprising:
computer usable code for determining that the reservation is no longer held at the first local cache;
computer usable code for querying a plurality of cache levels to identify a cache level holding the reservation;
computer usable code for identifying the coherence level as holding the reservation;
computer usable code for requesting the conditional store at the coherence level; and
computer usable code for returning an indication of success of the conditional store at the coherence level.
